(19) United States
(12) Patent Application Publication
(10) Pub. No.: US 2025/0036913 A1
(43) Pub. Date: Jan. 30, 2025

(54) REDUCING GREENHOUSE GASES THROUGH EVALUATION AND DEPLOYMENT OF WILDFIRE MITIGATION ACTIONS USING MACHINE LEARNING

(71) Applicant: X Development LLC, Mountain View, CA (US)

(72) Inventors: Akshina Gupta, Warren, NJ (US); Eliot Julien Cowan, Atherton, CA (US)

(21) Appl. No.: 18/358,695

(22) Filed: Jul. 25, 2023

(51) Int. Cl. G06N 3/04

(52) U.S. Cl. CPC G06N 3/04

(57) ABSTRACT

Methods, systems, and apparatus for using one or more machine learning (ML) models to mitigate effects of climate change by evaluating impact of wildfire mitigation actions (WMAs) for selective deployment of WMAs.

### TECHNICAL FIELD

This specification relates to wildfire mitigation, and more specifically, to using two or more machine learning (ML) models to determine the potential impact of one or more wildfire mitigation actions (WMAs) on characteristics of a wildfire within a geographic region. ML-evaluation of WMAs enable deployment of WMAs to optimize reduction of greenhouse gases.

### BACKGROUND

Natural disasters are increasing in both frequency and intensity. Example natural disasters can include wildfires, hurricanes, tornados, and floods, among several others. Natural disasters often result in significant loss that can include a spectrum of economic losses, property losses, and physical losses (e.g., deaths, injuries). Consequently, significant time and effort is expended not only predicting occurrences of natural disasters, but characteristics of natural disasters such as duration, severity, spread, and the like. Technologies, such as machine learning (ML), have been leveraged to generate predictions around natural disasters. However, natural disasters present a special use case for predictions using ML models, which results in technical problems that must be addressed to generate reliable and actionable predictions.

### SUMMARY

This specification describes systems, methods, devices, and other techniques relating to utilizing machine learning (ML) to evaluate the potential impact of wildfire mitigation actions (WMAs) on characteristics of a wildfire using two or more ML models. ML-evaluation of WMAs enable deployment of WMAs to optimize reduction of greenhouse gases.

In general, innovative aspects of the subject matter described in this specification can include actions of receiving region data representative of a region including a geographical area, receiving WMA data representative of a first set of WMAs that is to be evaluated for potential execution in the region, providing, by a first WMA model processing the region data, first predicted WMA region data representative of the region, if the first set of WMAs was executed in the region, providing, by a wildfire characteristic model processing the region data, pre-WMA characteristic data representative of one or more pre-WMA characteristics of a wildfire in the region, providing, by the wildfire characteristic model processing the first predicted WMA region data, first post-WMA characteristic data representative of one or more post-WMA characteristics of a wildfire in the region, and generating first impact results based on the pre-WMA characteristic data and the first post-WMA characteristic data, the first impact results representing an impact of the first set of WMAs on the one or more pre-WMA characteristics, if the first set of WMAs is executed in the region. Other implementations of this aspect include corresponding systems, apparatus, and computer programs, configured to perform the actions of the methods, encoded on computer storage devices.

These and other implementations can each optionally include one or more of the following features: actions further include selecting the first WMA model from a plurality of WMA models in response to the WMA data, the first WMA model being trained specific to the first set of WMAs; actions further include providing, by a second WMA model processing the region data, second predicted WMA region data representative of the region, if a second set of WMAs was executed in the region, the second set of WMAs being different from the first set of WMAs, the second WMA model being specific to the second set of WMAs, providing, by the wildfire characteristic model processing the second predicted WMA region data, second post-WMA characteristic data representative of one or more post-WMA characteristics of a wildfire in the region, and generating second impact results based on the pre-WMA characteristic data and the second post-WMA characteristic data, the second impact results representing an impact of the second set of WMAs on the one or more pre-WMA characteristics, if the second set of WMAs is executed in the region; the first WMA model is trained using training data including pre-WMA region data and post-WMA region data, the pre-WMA region data representing properties of each region in a set of regions prior to the set of WMAs being executed in each region of the set of regions, and the post-WMA region data representing properties of each region in the set of regions after the set of WMAs is actually executed in each region; post-WMA region data for each region is generated within a threshold time of the set of WMAs being actually executed in each region; post-WMA region data for each region is generated within a time period of a year that corresponds to the time period of a previous year, in which the set of WMAs is actually executed in each region; the set of WMAs comprises one or more of brush clearing, prescribed burn, and fire line formation; and the first WMA learning model is one of a convolution neural network (CNN), a residual neural network (RNN), and a generative adversarial network (GAN).

The present disclosure also provides a non-transitory computer-readable storage medium coupled to one or more processors and having instructions stored thereon which, when executed by the one or more processors, cause the one or more processors to perform operations in accordance with implementations provided herein.

It is appreciated that the methods and systems in accordance with the present disclosure can include any combination of the aspects and features described herein. That is, methods and systems in accordance with the present disclosure are not limited to the combinations of aspects and features specifically described herein, but also include any combination of the aspects and features provided.

Particular implementations of the subject matter described in this specification can be executed so as to realize one or more of the following advantages. Implementations of the present disclosure improve on traditional approaches by providing a WMA evaluation platform that employs multiple ML models. In some implementations, a first model predicts a representation of a WMA being executed within a region, if the WMA were to be applied to the region, and a second model predicts one or more characteristics of a fire (e.g., a risk of wildfire, an intensity of wildfire, a rate of spread of wildfire, a duration of wildfire) for the region based on the representation of the WMA within the region. By determining the likely impact of a WMA and using that result to predict the impact of a potential wildfire event, the WMA evaluation platform enables planners to determine and execute the most effective wildfire mitigation strategies.

Further, by using a ML model to generate the representation of the WMA being executed within the region, implementations of the present disclosure provide improvements over traditional approaches. For example, the impact of a WMA across all layers of region data representative of the region can be accurately and comprehensively expressed. This not only enables time- and resource-efficient evaluation of WMA impact on wildfire characteristics for the region, but also obviates a need for computer-executed editing programs and manual manipulation of region data to simulate execution of a WMA. Further, because an effect of one or more WMAs is not well understood, implementations of the present disclosure enable regional and/or temporally recent understanding of the effect(s) of WMA(s) rather than a general one. Implementations of the present disclosure can be time- and resource-efficiently extended, if a new data layer is added, because there is no dependency on scientifically understanding the relationship between each data layer.

As described herein, implementations of the present disclosure help mitigate effects of climate change. For example, implementations of the present disclosure optimize reduction of greenhouse gases, such as carbon dioxide (CO₂), by selecting WMAs that mitigate wildfires more effectively than other WMAs. Mitigation of wildfires reduces the number of flora that are burned in wildfires, which directly reduces gases, such as CO₂, that are released to the atmosphere through the burning process. Such florae that are saved from wildfires are able to continue consuming CO₂ through photosynthesis and continue to contribute to cooling of the atmosphere through release of water vapor. Implementations of the present disclosure enable less effective WMAs to be avoided, thereby conserving flora that would have otherwise been lost to the WMAs. As such, these conserved florae are able to continue consuming CO₂ through photosynthesis and continue to contribute to cooling of the atmosphere through release of water vapor.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example wildfire mitigation action (WMA) evaluation platform in accordance with implementations of the present disclosure.

FIG. 2 depicts example representations of data layers of pre-WMA region data and post-WMA region data.

FIG. 3 is a diagram of an example system for providing a WMA model for use in evaluating an impact of WMAs on characteristics of a wildfire.

FIG. 4 is a flow diagram of an example process for evaluating impact of WMAs on characteristics of a wildfire.

Like reference numbers and designations in the various drawings indicate like elements.

### DETAILED DESCRIPTION

Implementations of the present disclosure are directed to evaluating an impact that a wildfire mitigation action (WMA) can have on characteristics of a wildfire, if the WMA were to be executed. More particularly, implementations of the present disclosure are directed to using two or more machine learning (ML) models to predict an impact that a WMA would have on characteristics of a wildfire that occurs within a region, if the WMA were to be executed within the region. ML-evaluation of WMAs enable deployment of WMAs to counter effects of climate change, such as optimizing reduction of greenhouse gases.

As described herein, implementations of the present disclosure help mitigate effects of climate change. For example, implementations of the present disclosure optimize reduction of greenhouse gases, such as carbon dioxide (CO₂), by selecting WMAs that mitigate wildfires more effectively than other WMAs. Mitigation of wildfires reduces the number of flora that are burned in wildfires, which directly reduces gases, such as CO₂, that are released to the atmosphere through the burning process. Such florae that are saved from wildfires are able to continue consuming CO₂ through photosynthesis and continue to contribute to cooling of the atmosphere through release of water vapor. Implementations of the present disclosure enable less effective WMAs to be avoided, thereby conserving flora that would have otherwise been lost to the WMAs. As such, these conserved florae are able to continue consuming CO₂ through photosynthesis and continue to contribute to cooling of the atmosphere through release of water vapor.

As described in further detail herein, region data is processed through a wildfire characteristic model to determine predicted pre-WMA characteristics of a wildfire that could occur in a region. The region data is processed through a WMA model to provide predicted WMA region data. The predicted WMA region data is representative of the region, if one or more specified WMAs were executed in the region before a wildfire occurs, and accounts for multiple data layers, as described in further detail herein. The predicted WMA region data is processed through the wildfire characteristic model to determine a predicted post-WMA characteristic of a wildfire in the region, such as whether an area within the region will burn. The pre-WMA characteristic and the post-WMA characteristic can be compared to determine an impact the one or more specific WMAs would have on a wildfire, if the WMA(s) were to be executed in the region.

Implementations of the present disclosure are described in further detail herein with reference to an example natural disaster, which includes wildfires. It is contemplated, however, that implementations of the present disclosure are applicable to any appropriate natural disaster. For example, implementations of the present disclosure can be used to determine potential impact of mitigation actions that are appropriate to a respective natural disaster.

To provide context for the subject matter of the present disclosure, and as introduced above, ML has been leveraged to generate predictions around natural disasters. For example, ML models can be used to generate predictions representative of characteristics of a natural disaster, such as likelihood of occurrence, duration, severity, spread, among other characteristics, of the natural disaster.

In further detail, one or more ML models can be trained to predict characteristics of a natural disaster using training data that is representative of characteristics of occurrences of the natural disaster, for example. Example types of ML models can include Convolutional Neural Networks (CNNs), Residual Neural Networks (RNNs), and Generative Adversarial Networks (GANs). The training data can include region data representative of properties of respective regions (e.g., geographical areas), at which the natural disaster has occurred. In some examples, each ML model predicts a respective characteristic of the natural disaster. Example ML models can include, without limitation, a risk model that predicts a likelihood of occurrence of the natural disaster in a region, a spread model that predicts a rate of spread of the natural disaster in the region, a spread model that predicts a spread of the natural disaster in the region, and an intensity model that predicts an intensity of the natural disaster. Characteristics of a natural disaster can be temporal. For example, a risk of wildfire is higher during a dry season than during a rainy season. Consequently, each ML model can be temporal. That is, for example, each ML model can be trained using training data representative of regions at a particular period of time. In addition, since the layers of training data all relate to the same region, and contain measurements made at or around the same time, one ML model can also “learn” temporal properties from the training data.

In further detail, the region data can include an image of the region and a set of properties of the region. More generally, the region data can be described as a set of data layers (e.g., N data layers), each data layer providing a respective type of data representative of a property of the region. In some examples, the data layers can number in the tens of data layers to hundreds of data layers. In some examples, each data layer includes an array of pixels, each pixel representing a portion of the region and having data associated therewith that is representative of the portion of the region. A pixel can represent an area (e.g., square meters (m²), square kilometers (km²)) within the region. The area that a pixel represents in one data layer can be different from the area that a pixel represents in another data layer. For example, each pixel within a first data layer can represent X km² and each pixel within a second data layer can represent Y km², where X≠Y.

An example, a data layer can include an image layer, in which each pixel is associated with image data, such as red, green, blue (RGB) values (e.g., each value ranging from 0 to 255). Another example layer can include a vegetation layer, in which, for each pixel, a normalized vegetation difference index (NVDI) value (e.g., in range of [−1, 1], lower values indicating absence of vegetation). Other example layers can include, without limitation, a temperature layer, in which a temperature value is assigned to each pixel, a humidity layer, in which a humidity value is assigned to each pixel, a wind layer, in which wind-related values (e.g., speed, direction) are assigned to each pixel, a barometric pressure layer, in which a barometric pressure value is assigned to each pixel, a precipitation layer, in which a precipitation value is assigned to each pixel, and an elevation layer, in which an elevation value is assigned to each pixel.

In some examples, pixel values can be partitioned into thresholds. For example, wind speeds over 20 kilometers per hour (kph) can be deemed “Wind_High”, wind speeds over 5 kph and not exceeding 20 kph can be deemed “Wind_Moderate,” wind speeds over 1 kph but not exceeding 5 kph can be deemed “Wind_Light” and wind speeds not exceeding 5 kph can be deemed “Wind_Calm.”

In general, data values for pixels of data layers can be obtained from various data sources including data sources provided by, for example, governmental entities, non-governmental entities, public institutions, and private enterprises. For example, data can be obtained from databases maintained by the National Weather Service (NWS), the United States Fire Service (USFS), and the California Department of Forestry and Fire Protection (CAL FIRE), among many other entities. For example, weather-related data for a region can be obtained from a web-accessible database (e.g., through a hypertext transfer protocol (HTTP), calls to an application programming interface (API)). In another example, data stored in a relational database can be retrieved through queries to the database (e.g., structured query language (SQL) queries).

Because values across the data layers can change over time, the region data can be temporal. For example, temperature values for the region can be significantly different in summer as compared to winter. Therefore, a data layer represents a characteristic of the region at a particular time point, and multiple data layers can represent the same characteristic in the same region, but at different time points.

Accordingly, the region data can include an array of N data layers (e.g., [I₁, I₂ . . . . I_{N}]). Each layer, Iᵢ, can include an array of pixels, [p_{1,1}, . . . , p_{i,j}], where each pixel contains a value for a property (e.g., vegetation, humidity, wind speed, etc.) at a point in space. Each layer can also include metadata describing the layer. For example, the metadata, M, can include the time T at which the characteristic was measures, points indicating the boundaries of the region, and the size of a pixel: [T, (x₁, y₁), (x₂, y₂), S], where T is the measurement time, (x₁, y₁) and (x₂, y₂) demarcate the region boundary, and S indicates the size of the pixel, e.g., in square meters. Therefore, a full representation of a layer k can be represented as lₖ=[p_{1,1}, . . . , p_{i,j}, M].

As training data, the region data, which can be referred to as region training data in the context of training, can include one or more characteristic layers that provides known characteristic data for respective characteristics of a natural disaster. The known characteristic data represents actual values of the respective characteristics as a result of the natural disaster. For example, a wildfire can occur within a region and, as a result, characteristics of intensity, spread, duration, and the like can be determined for the natural disaster. Accordingly, as training data, the region data can include, for example, p_{i,j}=[l₁, l₂, . . . , lₙ, . . . , C_{A,i,j}^{K}, C_{B,i,j}^{K}, . . . ], where lᵢ are data layers and C_{A,i,j}^{K} and C_{A,i,j}^{K} are respective known (K) characteristics (i.e., historical characteristics) of a natural disaster of a particular type (A) in question, where types of natural disasters can include wildfires, floods, hurricanes, etc.

One or more ML models are trained using the region training data. The training process can depend on a type of the ML model. In general, the ML model is iteratively trained, where, during an iteration, also referred to as epoch, one or more parameters of the ML model are adjusted, and an output (e.g., predicted characteristic value) is generated based on the training data. For each iteration, a loss value is determined based on a loss function.

The loss value represents a degree of inaccuracy of the output of the ML model as compared to a desired or known value (e.g., known characteristic). The loss value can be described as a representation of a degree of difference between the output of the ML model and the desired output of the ML model for a particular example. The desired output for a training example can be included in the training example. Examples of loss functions can include mean squared error (MSE) and log loss.

In some examples, if the loss value does not meet an expected value (e.g., is not equal to zero), parameters of the ML model are adjusted in another iteration (epoch) of training. In some examples, the iterative training continues for a pre-defined number of iterations (epochs). In some examples, the iterative training continues until the loss value meets the expected value or is within a threshold range of the expected value.

To generate predictions, layers of region data representative of a region, for which predictions are to be generated, are provided as input to a (trained) ML model, which generates a predicted characteristic for each pixel within the region data. An example output of the ML model can include p_{i,j}=[C_{i,j}^{P}], where C is a characteristic predicted (P) by the ML model. In some implementations, a model can make multiple predictions. For example, if the model makes k predictions, the output can be a vector of predictions, [p_{1,i,j},p_{2,i,j}, . . . , p_{k,i,j}] Example characteristics can include, without limitation, likelihood of occurrence (e.g., risk), a rate of spread, an intensity, and a duration. In some examples, an image of the region can be displayed to visually depict the predicted characteristic across the region. For example, different values of the characteristic can be associated with respective visual cues (e.g., colors, shades of colors), and the predicted characteristic can be visually displayed as a heatmap over an image of the region.

While ML models are useful in generating predictions, natural disasters present a special use case for predictions using ML models. More particularly, various technical problems arise that must be addressed to generate reliable and actionable predictions.

For example, in the context of wildfires, one or more WMAs can be considered for implementation within a region. In general, WMAs are implemented to mitigate occurrence of a wildfire (e.g., prevent a wildfire, reduce risk of wildfire), and, if a wildfire occurs, mitigate characteristics of the wildfire (e.g., limit spread, reduce intensity, reduce duration). Example WMAs can include prescribed burns, brush thinning, and forming fire lines. However, regions susceptible to fire may be too large, or otherwise unsuited to practically employ every WMA at all locations. Further, WMAs are only effective in regions near to where they are applied. That is, for example, a WMA applied at one location is unlikely to have a measurable impact on another location a significant distance away. In addition, applying multiple WMAs, even at a single location, can be cost prohibitive.

For at least these reasons, it is beneficial to determine which regions are likely to most benefit from WMAs, and in those regions, to determine which particular WMA or WMAs are most beneficial. Accordingly, this specification describes techniques for predicting the impact one or more WMAs will have on one or more characteristics of a wildfire using ML. Example characteristics can include, without limitation, a risk of wildfire, an intensity of wildfire, a rate of spread of wildfire, and a duration of wildfire. As described herein, implementations of the present disclosure enable targeting of WMAs to respective regions at which the WMAs will be most effective.

As discussed above, ML models can be used to predict one or more characteristics of a wildfire at particular regions. ML models can be used to determine the effectiveness of potential WMAs at the particular regions. For example, a ML model can predict a risk of wildfire prior to a WMA being implemented based on region data representative of the region. In a traditional approach to evaluating WMAs, region data is manually altered to represent the region after a WMA is executed, if the WMA were to be executed. For example, to simulate the result of a prescribed burn (e.g., jackpot burn, underburn, pile burn), a traditional approach can require that the region data be manually modified to reflect the results of a prescribed burn by changing the color values for pixels in an image layer of the region data (e.g., replacing trees or brush within an image with grass or dirt). In another example, NVDI values can be set to zero in pixels of a vegetation layer of the region data to simulate the removal of vegetation.

However, such approaches require substantial time and computing resources to modify the region data. For example, one or more editing programs need to be executed to enable a user to manually modify the region data (e.g., changing green to brown, adjusting NVDI values of respective pixels). Further, adjustment to the region data must accurately reflect the result of the WMA. This is not achievable to a requisite degree of accuracy absent deep knowledge of the region, effects modifications have across all data layers, and of the particular WMA. Even with such knowledge, the impact a WMA can have across all data layers can be so complex, that manual modification of data values across all data layers and all pixels in each data layer is impossible. For example, and as discussed above, region data can include tens to hundreds of data layers, and manual modification cannot accurately touch every pixel of all data layers.

In view of the foregoing, implementations of the present disclosure improve on traditional approaches by providing a WMA evaluation platform that employs multiple ML models. In some implementations, a first model predicts a representation of a WMA being executed within a region, if the WMA were to be applied to the region, and a second model predicts one or more characteristics of a fire (e.g., a risk of wildfire, an intensity of wildfire, a rate of spread of wildfire, a duration of wildfire) for the region based on the representation of the WMA within the region. By determining the likely impact of a WMA and using that result to predict the impact of a potential wildfire event, the WMA evaluation platform enables planners to determine and execute the most effective wildfire mitigation strategies.

Further, by using a ML model to generate the representation of the WMA being executed within the region, implementations of the present disclosure provide improvements over traditional approaches. For example, the impact of a WMA across all layers of region data representative of the region can be accurately and comprehensively expressed. This not only enables time- and resource-efficient evaluation of WMA impact on wildfire characteristics for the region, but also obviates a need for computer-executed editing programs and manual manipulation of region data to simulate execution of a WMA. Further, because an effect of one or more WMAs is not well understood, implementations of the present disclosure enable regional and/or temporally recent understanding of the effect(s) of WMA(s) rather than a general one. Implementations of the present disclosure can be time- and resource-efficiently extended, if a new data layer is added, because there is no dependency on scientifically understanding the relationship between each data layer.

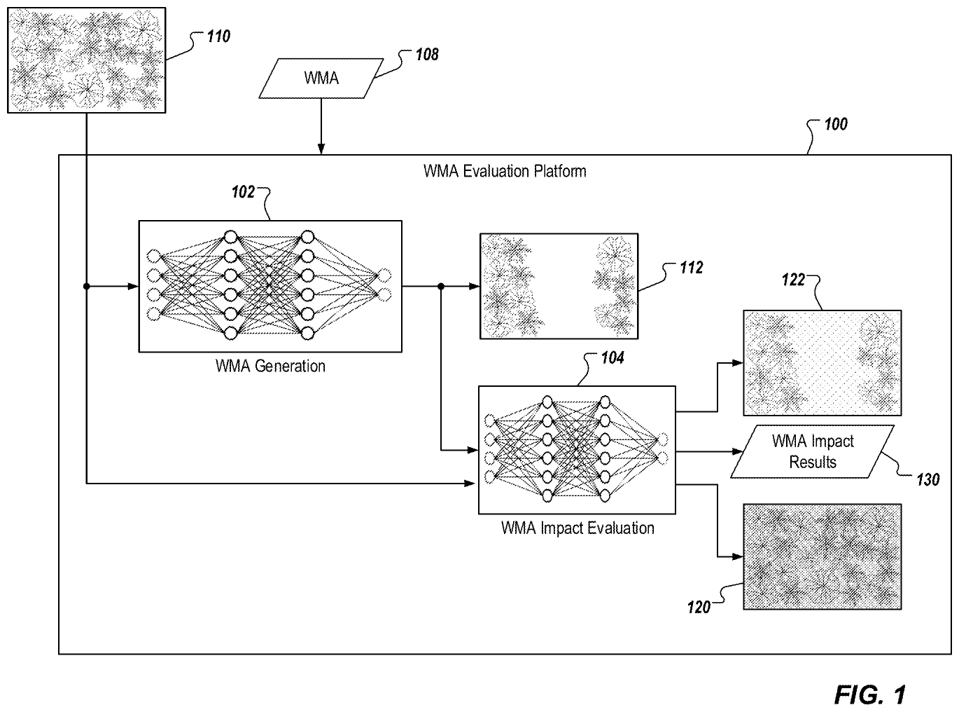

FIG. 1 is a diagram of an example WMA evaluation platform 100 in accordance with implementations of the present disclosure. The WMA evaluation platform 100 (“platform”) includes a WMA generation engine 102 and a wildfire impact evaluation engine 104. In some examples, and as described in further detail herein, the WMA generation engine 102 executes a WMA model that predicts the results, expressed as layers of data, of applying one or more WMAs on a region. In some examples, and as described in further detail herein, the WMA impact evaluation engine 104 evaluates an impact of the one or more WMAs on the one or more characteristics of a fire (e.g., a risk of wildfire, an intensity of wildfire, a rate of spread of wildfire, a duration of wildfire) associated with the region. In some examples, the WMA evaluation engine 104 executes one or more wildfire models that respectively predict one or more characteristics of a wildfire for the region. Example wildfire models can include a wildfire hazard model that predicts a likelihood of wildfire (fire risk) in the region and a wildfire spread model that predicts a rate of fire spread, if a wildfire were to occur in the region. The WMA evaluation engine 104 can compare the predicted characteristics of a wildfire on a region that has had one or more WMAs applied to the characteristics of a region without such WMAs applied.

As depicted in FIG. 1, the WMA evaluation platform 100 receives WMA data 108 and region data 110. In some examples, the WMA data 108 indicates one or more WMAs that are to be evaluated for the region, and the region data includes data representative of a region. In some examples, and as discussed above, the region data includes one or multiple data layers (e.g., N data layers), each data layer representing a respective property of the region. For example, as depicted in FIG. 1, the region data 110 includes an image layer visually depicting the region.

As depicted in FIG. 1, the region data 110 is provided as input to the WMA generation engine 102, which processes the region data 110 through a WMA model to provide predicted WMA region data 112. As described herein, the predicted WMA region data 112 is representative of the region, if one or more WMAs (the WMA(s) indicated in the WMA data 108) had been applied to the region. In some examples, the predicted WMA region data 112 can include a set of post-WMA properties of the region. For example, as depicted in FIG. 1, the predicted WMA region data 112 includes an image layer visually depicting the region after one or more WMAs are applied (e.g., brush clearing, fire line formation). In the example of FIG. 1, a comparison of the image layer of the region data 110 and the image layer of the predicted WMA region data 112 reveals removal of vegetation within a middle portion of the region after application of one or more WMAs to the region (e.g., brush thinning, prescribed burn).

In some implementations, the region data 110 is provided as input to the WMA impact evaluation engine 104, which processes the region data 110 through one or more wildfire models to provide pre-WMA characteristic data 120. The pre-WMA characteristic data 120 is representative of one or more characteristics of the region before applying the WMA(s) to the region (i.e., no WMA being applied to the region). In accordance with implementations of the present disclosure, the predicted WMA region data 112 is also provided as input to the WMA impact evaluation engine 104, which processes the predicted WMA region data 112 through the one or more wildfire models to provide post-WMA characteristic data 122. The post-WMA characteristic data 122 is representative of the one or more characteristics of the region had the WMA(s) been applied to the region.

In some implementations, the WMA impact evaluation engine 104 provides WMA impact results 130. In some examples, the WMA impact evaluation engine 104 compares the pre-WMA characteristic data 120 to the post-WMA characteristic data 122 to determine the WMA impact results 130. For example, the pre-WMA characteristic data 120 can include a first set of wildfire characteristics predicted for the region (e.g., [R₁,I₁,S₁], where R is a wildfire risk, I is an intensity, and S is a rate of spread) and the post-WMA characteristic data 120 can include a second set of wildfire characteristics predicted for the region (e.g., [R₂,I₂,S₂]). Respective characteristics between the no-WMA characteristic data 120 and the WMA characteristic data 122 can be compared to determine one or more impacts that the WMA(s) would have on the region, if applied. For example, if R₂<R₁. it is shown that the WMA(s) reduce the risk of fire in the region. Further, a degree of impact can be determined (e.g., percent reduction/increase).

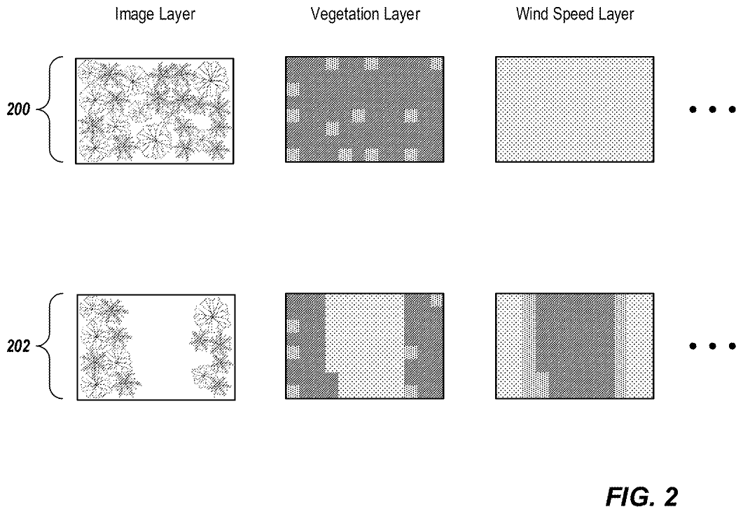

FIG. 2 depicts example representations of data layers of pre-WMA region data 200 and post-WMA region data 202. In the example of FIG. 2, example data layers include an image layer, a vegetation layer, and a wind speed layer. Although example data layers are depicted for purposes of illustration, implementations of the present disclosure are not limited to the data layers discussed herein. For example, and as noted above, region data can include tens to hundreds of data layers or more.

In the example of FIG. 2, the pre-WMA region data 200 represents a region without application of any WMA (e.g., the region data 110 of FIG. 1), and the post-WMA region data 202 is generated by a ML model (e.g., a WMA model executed by the WMA generation engine 102 of FIG. 1) to represent the region, if one or more WMAs were to be applied to the region (e.g., the predicted WMA region data 112 of FIG. 1). The image layer includes image values (e.g., RGB values) for pixels, the vegetation layer includes vegetation values (e.g., NDVI values) for pixels, and the wind speed layer provides wind speed values for pixels. In the example of FIG. 2, and for purposes of illustration, values are represented as shades within each layer (e.g., as opposed to numerical values per pixel, which would be provided in the respective data layers). Also in the example of FIG. 2, in the vegetation layer and the wind speed layer, darker shades indicate higher values and lighter shades indicate lower values. In the example of FIG. 2, pixels of the vegetation layer and the wind speed layer are larger than pixels of the image layer.

In comparing the image layers, it is visually depicted that vegetation has been removed from a middle portion of the region. That is, the WMA model that processed the region data removed vegetation from a middle portion of the region. In comparing the vegetation layers, it is graphically depicted that vegetation values have decreased in the middle portion of the region. That is, the WMA model that processed the region data reduced vegetation values in the middle portion, which results from vegetation being removed from the middle portion of the region. In comparing the wind speed layers, it is graphically depicted that wind speed values have increased in the middle portion of the region. That is, the WMA model that processed the region data increased wind speed values in the middle portion, which results from vegetation being removed from the middle portion of the region (e.g., absence of vegetation enables freer airflow through the middle portion).

In some implementations, the WMA model that generates the WMA region data is specific to a set of WMAs, the set including one or more WMAs. For example, the WMA model can be specific to vegetation thinning (i.e., the set of WMAs only includes vegetation thinning). As another example, the WMA model can be specific to vegetation thinning and fire line formation (i.e., the set of WMAs includes vegetation thinning and fire line formation). In some examples, a set of WMA models can be provided, each WMA model being specific to a respective set of WMAs. For example, a first WMA model can be specific to a first set of WMAs and a second WMA model can be specific to a second set of WMAs, the first set of WMAs being different from the second set of WMAs.

In some implementations, and as described in further detail herein, the WMA model is trained using WMA region data representative of a plurality of regions, each region having had one or more WMAs actually applied thereto. In some examples, the region data includes, for each region, a set of WMA data that includes, without limitation, a type of WMA (or types of WMAs, if more than one WMA) applied, a set of pre-WMA region data, and a set of post-WMA region data. In some examples, the set of pre-WMA region data is representative of a respective region before the WMA was applied, and the set of post-WMA region data is representative of the respective region after the WMA was actually applied. In some examples, the set of pre-WMA region data includes one or more properties of the respective region prior to applying the WMA. Example properties include, without limitation, image, vegetation, temperature, precipitation, wind speed, wind direction, and the like.

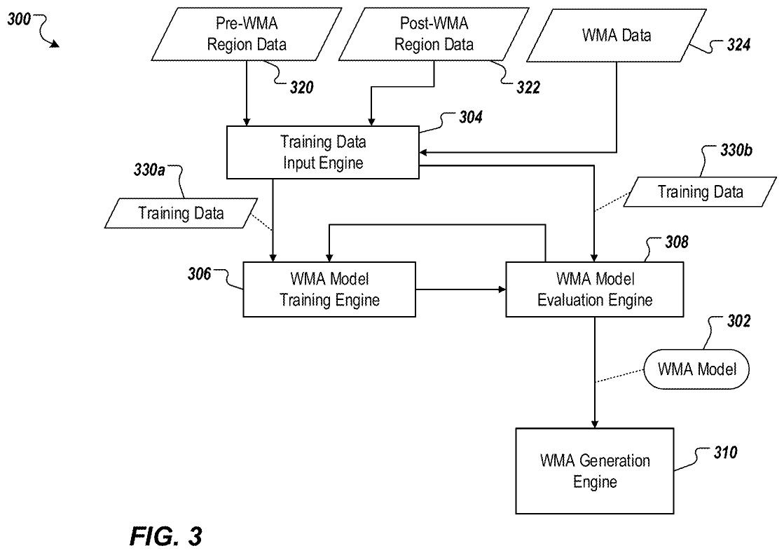

FIG. 3 is a diagram of an example system 300 for providing a WMA model 302 for use in evaluating an impact of WMAs on characteristics of a wildfire. As depicted in FIG. 3, the system 300 can include a training data input engine 304, a WMA model training engine 306, a WMA model evaluation engine 308, and a WMA generation engine 310. The training data input engine 304 receives training data that is used to train one or more WMA models 302. In the example of FIG. 3, the training data can include pre-WMA region data 320, post-WMA region data 322, and WMA data 324 representative of multiple regions in which WMAs were actually executed. In accordance with implementations of the present disclosure, the pre-WMA region data 320 represents properties of respective regions prior to any WMA indicated in the WMA data 324 being executed in the respective regions, and the post-WMA region data 322 represents properties of respective regions after WMA(s) indicated in the WMA data 324 were actually executed in the respective regions. That is, each of the regions is a region, in which the WMA(s) indicated in the WMA data 324 were actually executed.

In further detail, the pre-WMA region data 320 and the post-WAM region data 322 can include data that describe various properties of each of the respective regions that may be related to wildfire characteristics in the respective regions. For example, both the pre-WMA region data 320 and the post-WMA region data can include data values for properties of image, vegetation, precipitation, wind (speed, direction), and the like.

In some examples, the WMA data 324 can include one or more descriptors representing a set of WMAs (e.g., one or more WMAs) in each of the respective regions represented by the pre-WMA region data 320 and the post-WMA region data 322. In some examples, a descriptor can be a value that maps to a WMA. For example, “0” can indicate no WMA, “1” can indicate underbrush clearing, “2” can indicate a controlled burn, “3” can indicate fire line formation, and so on. For example, WMA data of [1, 3] indicates a set of WMAs that includes underbrush clearing and fire line formation. In another example, the descriptor can be a one-hot encoding representing the set of WMAs. For example, each place in a binary string can indicate a respective WMA and a value indicates whether the WMA was performed. As an illustrative example, 0101, can indicate a set of WMAs including underbrush clearing and fire line formation, because the second place (underbrush clearing) and the third place (fire line formation) each include a value of 1.

In some implementations, WMA data is included in each of the pre-WMA region data 320 and the post-WMA region data 322 instead of the WMA data 324 separately. For example, each of the pre-WMA region data 320 and the post-WMA region data can include a WMA data layer (e.g., layer N+1) that indicates, for each pixel, absence or execution of one or more WMAs within a configured period (e.g., 1 month). For example, in a WMA data layer of the pre-WMA region data 320, each pixel can be assigned a value of 0, indicating absence of a WMA, and, in a WMA data layer of the post-WMA region data 322, some pixels can be assigned a value of 0, indicating absence of a WMA, and other pixels can be assigned a non-zero value, indicating execution of a WMA (e.g., 0001 indicating underbrush clearing, 0100 indicating fire line formation and 0101 indicating both underbrush clearing and fire line formation).

In accordance with implementations of the present disclosure, the pre-WMA region data 320 and the post-WMA region data 322 are temporally similar. That is, the pre-WMA region data 320 and the post-WMA region data 322 are representative of the region within a similar timeframe. In this manner, the pre-WMA region data 320 and the post-WMA region data 322 provide temporally-consistent representations of the region (e.g., both represent a dry season, a rainy season, summer, winter). In some examples, the time frame can be a period of time over which data in each of the pre-WMA region data 320 and the post-WMA region data 322. Example timeframes can include days, weeks, months, seasons.

In some examples, data for each region of the post-WMA region data 322 is generated within a threshold time (e.g., days, weeks, month) of the WMA(s) being actually executed in each region. For example, data for each region of the post-WMA region data is generated within two weeks of the WMA(s) being actually executed in each region. In some examples, data for each region of the post-WMA region data 322 for each region is generated within a time period of a year that corresponds to the time period of a previous year, in which the WMA(s) is/are actually executed in each region. For example, if the WMA(s) is/are executed in spring of 2021, the data for each region of the post-WMA region data 322 is generated in spring of 2022.

In some examples, the training data input engine 304 can pre-process and aggregate the pre-WMA region data 320, the post-WMA region data 322, and the WMA data 324 (e.g., if not already included in the pre-WMA region data 320 and the post-WMA region data 322). In some examples, the training data input engine 304 provides a first set of training data 330a and a second set of training data 330b. The first set of training data 330a is used to train the WMA model 302 and the second set of training data 330b being used to validate the WMA model 302. The first set of training data 330a included pre-WMA region data that is to be input to the WMA model 302 during training to generate output, and post-WMA region data that is compared to the output (e.g., at each epoch). That is, the post-WMA region data functions as a ground truth that the output is compared to (e.g., using a loss function).

After the WMA model 302 is trained, the WMA model evaluation engine 308 evaluates the WMA model 302 using the second set of training data 330b. For example, pre-WMA region data of the second set of training data 330b is input to the WMA model 302, which provides an output that is compared to respective post-WMA region data to determine an accuracy of the WMA model. In some examples, an accuracy of the WMA model 302 is compared to a threshold accuracy. If the accuracy of the WMA model 302 does not at least meet the threshold accuracy, the WMA model 302 can be retrained. If the accuracy of the WMA model 302 at least meets the threshold accuracy, the WMA model 302 is deployed to the WMA generation engine 310 for inferencing (e.g., generating the predicted WMA region data 112 based on the region data 110).

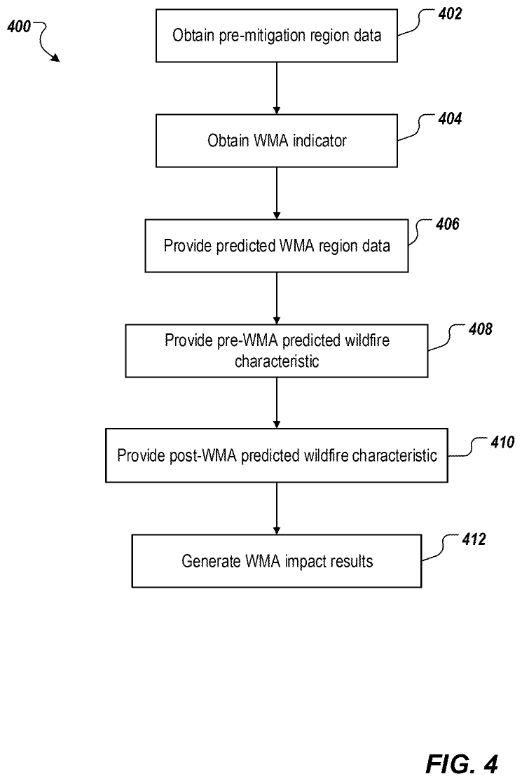

FIG. 4 is a flow diagram of an example process in accordance with implementations of the present disclosure. For convenience, the process 400 will be described as being performed by a system of one or more computers located in one or more locations. For example, a system that includes a wildfire mitigation action (WMA) evaluation platform, e.g., the WMA evaluation platform of FIG. 1, appropriately programmed in accordance with this specification, can perform the process 400.

The platform obtains pre-mitigation region data (402). As noted above, the pre-mitigation region data can be obtained from data sources such as databases maintained by the National Weather Service (NWS), the United States Fire Service (USFS), and the California Department of Forestry and Fire Protection (CAL FIRE), among many other entities. The data can be obtained using a protocol appropriate to the data source. For example, if the data source is a relational database, data can be obtained using SQL calls appropriately constructed for the data source. If the data are stored on a web server, data can obtained using appropriately structured Hypertext Transfer Protocol (HTTP) requests.

The platform can make one or more requests to one or more data sources. In response to each request, the platform can obtain data that describes one or more properties of one or more regions.

For each region and each property obtained, the platform can create a data layer. As described above, a layer contains data relevant to a property of a region described by the layer. A layer contains an array of pixels (P) where each pixel Pij, contains data relevant to a particular location within the region. The platform can add the data from the response to a data layer using the pseudo-code shown in Listing 1, below.

Listing 1

```
for each property (Tₖ) in the response
  set i to 0
  create data layer Lᵢ
  for each data item (D) in Tₖ
    create a pixel (P_{i,j}) corresponding to the location of the data item
```

In addition, the platform can store metadata associated with each layer, including the time the measurement was taken, the location of the region, that the layer represents a pre-mitigation region, and so on, as described above.

The platform obtains a WMA indicator that is representative of one or more WMAs that are to be evaluated for potential execution in the region. The platform can obtain the WMA indicator from a user interacting with a user interface provided by the platform. In some implementations, the platform can provide a web page that includes a selectable list of available WMAs. A user can select one or more WMAs, for example, by checking a box next to the selected WMAs, and submitting the selections to the platform, for example, by pressing a “submit” button on the web page. The indicator then includes the list of WMAs selected by the user.

The platform provides first predicted WMA region data representative of the region, if the first set of WMAs was executed in the region (406). The platform processes an input that includes the pre-mitigation region data and the WMA indicator using a machine learning model that is configured to produce predicted output that describes the region after the WMA(s) specified in the WMA indicator are performed.

The machine learning model can be configured to produce such predicted output by a training system, such as the training system 300 of FIG. 3, using the training process described above. A WMA model training engine in the training system can use a training set that includes, for each training example, pre-WMA region data, post-WMA region data, and the WMAs that were applied between the times the pre-WMA region data and post-WMA region data were measured.

The pre-WMA and post-WMA region data can represent properties of each region before and after, respectively, the set of WMAs is executed in each region. The post-WMA region data can be generated within a threshold time of the set of WMAs being executed in each region. Examples of threshold times can be several days, a week, a month, before the season changes, and so on.

In some implementations, the threshold can relate to the time of year instead of a duration of time. The post-WMA region data can be generated within a time period of a year that corresponds to the time period of a previous year, in which the set of WMAs is actually executed in each region. For example, if a WMA is executed in early Spring in one year, the pre-WMA data can be measured before the WMA in that year, and the post-WMA data can be measured in early Spring the following year.

Further, the system can use the post-WMA region data as the desired outcome for pre-WMA region data for the given WMA data in each training example. For each instance of pre-WMA region data and corresponding post-WMA region data (that is, measurement of the same properties before and after WMAs are performed), the model can compute predicted values for each property at each pixel. The predictions can then be compared to desired outcomes as specified in the post-WMA region data to generate a loss metric. The system can alter the model's parameters such that the loss function is reduced across training epochs, for example, using gradient descent or stochastic gradient descent. The result of the training is a machine learning model that is configured to produce predicted output that describes the region after the WMA specified in the WMA indicator are performed.

In some implementations, the platform can maintain multiple WMA machine learning models, with each model trained to make predictions relating to one WMA or to a particular set of WMAs. In such cases, rather than training a single model on all training examples, the platform can partition the training examples according to the WMA(s) applied, and use the subset of training examples relevant to each particular model. For example, if one WMA is a brush clearing, a machine learning model can be trained only on examples where the WMA was brush clearing.

In such implementations, when the platform processes an input that includes the pre-mitigation region data and the WMA indicator using a machine learning model that is configured to produce predicted output that describes the region after the WMA specified in the WMA indicator are performed, the platform first uses the WMA indicator to select a machine learning model appropriate to the WMA, then processes the input using that model. In cases where no specific model exists, the platform can use a general model trained on all training examples.

The platform provides pre-WMA characteristic data representative of one or more pre-WMA characteristics of a wildfire in the region (408). The platform processes an input that includes the pre-mitigation region data and the WMA indicator using a wildfire characteristic machine learning model that is configured to produce predicted output that describes the region after a fire event has occurred. The wildfire characteristic machine learning model can be trained using training examples that include data describing a region before a fire occurs and the characteristics of a fire that burns in region.

The platform provides first post-WMA characteristic data representative of one or more post-WMA characteristics of a wildfire in the region (410). The platform processes an input that includes the post-mitigation region data and the WMA indicator using a wildfire characteristic machine learning model, which can be the wildfire characteristic model used in operation 408, that is configured to produce predicted output that describes the region after a fire event has occurred.

The platform generates first impact results based on the pre-WMA characteristic data and the first post-WMA characteristic data (412). The first impact results can be generated by comparing the pre-WMA characteristic data to the post-WMA characteristic data. As noted above, the platform can compare the predicted characteristics for the pre-WMA predictions and the post-WMA prediction.

In one example, the platform computes the difference in predicted values of the characteristic data. The platform can compute the difference on a pixel-wise basis and store the results in a result data layer. For example, for characteristic k at pixel (i,j), the impact (I) can be computed as: I_{i,j}^{k}=p_{i,j}^{post}−p_{i,j}^{pre}

In another example, the platform can compute the percentage change. The platform can again compute the difference on a pixel-wise basis and store the results in a result data layer. For example, for characteristic k at pixel (i,j), the impact (I_{i,j}^{k}) can be computed as: (p_{i,j}^{post}−p_{i,j}^{pre})/p_{i,j}^{pre}.

The platform can further compute the overall impact by combining the impact values of all pixels. For example, if the pixel values can be combined using summation as: Σᵢ Σⱼ I_{i,j}

In one specific example, if the wildfire characteristic model predicts whether a pixel will burn, each pixel can contain a 1 value if the pixel is predicted to burn and a 0 value otherwise. The prediction from processing the fire characteristic model on the pre-WMA region data indicates which pixels are predicted to burn if a WMA is not applied. Similarly, the prediction from processing the fire characteristic model on the post-WMA region data indicates which pixels are predicted to burn if a WMA is applied. The difference of the values at each pixel, which can be computed using I_{i,j}=p_{i,j}^{post}−p_{i,j}^{pre}, indicate the impact of the WMA. Specifically, a value of −1 indicates that pixel burned in the pre-WMA prediction and not in the post-WMA prediction, a value of 0 indicates that the pixel either burned or did not burn in both cases, and a value of 1 indicates that the pixel did not burn in the pre-WMA prediction and did burn in the post-WMA prediction. Therefore, by summing the impact values, the system can determine the number of pixels “saved” from burning, with a larger negative number indicating more pixels saved.

To compare the effectiveness of WMAs, or combinations of WMAs, the platform can repeat the steps of providing predicted region data after one or more WMAs, providing predicted wildfire characteristics for the predicted region data, and generating impact results. For example, the platform could perform these steps both for brush clearing and for a prescribed burn, producing impact results for both. In fact, the platform can perform the steps for brush clearing, a prescribed burn and the combination of brush clearing and a prescribed burn, producing impact results for all three scenarios. The various impact results can then be used to select the most effective WMA for actual implementation at the region.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Data processing apparatus for implementing machine learning models can also include, for example, special-purpose hardware accelerator units for processing common and compute-intensive parts of machine learning training or production (i.e., inference, workloads).

Machine learning models can be implemented and deployed using a machine learning framework (e.g., a TensorFlow framework, a Microsoft Cognitive Toolkit framework, an Apache Singa framework, an Apache MXNet framework).

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method of using one or more machine learning (ML) models to mitigate effects of climate change by evaluating impact wildfire mitigation actions (WMAs) for selective deployment of WMAs, the method being executed by one or more processors and comprising:
receiving region data representative of a region comprising a geographical area;
receiving WMA data representative of a first set of WMAs that is to be evaluated for potential execution in the region;
providing, by a first WMA model processing the region data, first predicted WMA region data representative of the region, if the first set of WMAs was executed in the region;
providing, by a wildfire characteristic model processing the region data, pre-WMA characteristic data representative of one or more pre-WMA characteristics of a wildfire in the region;
providing, by the wildfire characteristic model processing the first predicted WMA region data, first post-WMA characteristic data representative of one or more post-WMA characteristics of a wildfire in the region; and
generating first impact results based on the pre-WMA characteristic data and the first post-WMA characteristic data, the first impact results representing an impact of the first set of WMAs on the one or more pre-WMA characteristics, if the first set of WMAs is executed in the region.

2. The method of claim 1, further comprising selecting the first WMA model from a plurality of WMA models in response to the WMA data, the first WMA model being trained specific to the first set of WMAs.

3. The method of claim 1, further comprising:
providing, by a second WMA model processing the region data, second predicted WMA region data representative of the region, if a second set of WMAs was executed in the region, the second set of WMAs being different from the first set of WMAs, the second WMA model being specific to the second set of WMAs;
providing, by the wildfire characteristic model processing the second predicted WMA region data, second post-WMA characteristic data representative of one or more post-WMA characteristics of a wildfire in the region; and
generating second impact results based on the pre-WMA characteristic data and the second post-WMA characteristic data, the second impact results representing an impact of the second set of WMAs on the one or more pre-WMA characteristics, if the second set of WMAs is executed in the region.

4. The method of claim 1, wherein the first WMA model is trained using training data comprising pre-WMA region data and post-WMA region data, the pre-WMA region data representing properties of each region in a set of regions prior to the set of WMAs being executed in each region of the set of regions, and the post-WMA region data representing properties of each region in the set of regions after the set of WMAs is actually executed in each region.

5. The method of claim 4, wherein post-WMA region data for each region is generated within a threshold time of the set of WMAs being actually executed in each region.

6. The method of claim 4, wherein post-WMA region data for each region is generated within a time period of a year that corresponds to the time period of a previous year, in which the set of WMAs is actually executed in each region.

7. The method of claim 1, wherein the set of WMAs comprises one or more of brush clearing, prescribed burn, and fire line formation.

8. The method of claim 1, wherein the first WMA learning model is one of a convolution neural network (CNN), a residual neural network (RNN), and a generative adversarial network (GAN).

9. A non-transitory computer storage medium encoded with a computer program, the computer program comprising instructions that when executed by a data processing apparatus cause the data processing apparatus to perform operations for using one or more machine learning (ML) models to mitigate effects of climate change by evaluating impact of wildfire mitigation actions (WMAs) for selective deployment of WMAs, the operations comprising:
receiving region data representative of a region comprising a geographical area;
receiving WMA data representative of a first set of WMAs that is to be evaluated for potential execution in the region;
providing, by a first WMA model processing the region data, first predicted WMA region data representative of the region, if the first set of WMAs was executed in the region;
providing, by a wildfire characteristic model processing the region data, pre-WMA characteristic data representative of one or more pre-WMA characteristics of a wildfire in the region;
providing, by the wildfire characteristic model processing the first predicted WMA region data, first post-WMA characteristic data representative of one or more post-WMA characteristics of a wildfire in the region; and
generating first impact results based on the pre-WMA characteristic data and the first post-WMA characteristic data, the first impact results representing an impact of the first set of WMAs on the one or more pre-WMA characteristics, if the first set of WMAs is executed in the region.

10. The non-transitory computer storage medium of claim 9, wherein operations further comprise selecting the first WMA model from a plurality of WMA models in response to the WMA data, the first WMA model being trained specific to the first set of WMAs.

11. The non-transitory computer storage medium of claim 9, wherein operations further comprise:
providing, by a second WMA model processing the region data, second predicted WMA region data representative of the region, if a second set of WMAs was executed in the region, the second set of WMAs being different from the first set of WMAs, the second WMA model being specific to the second set of WMAs;
providing, by the wildfire characteristic model processing the second predicted WMA region data, second post-WMA characteristic data representative of one or more post-WMA characteristics of a wildfire in the region; and
generating second impact results based on the pre-WMA characteristic data and the second post-WMA characteristic data, the second impact results representing an impact of the second set of WMAs on the one or more pre-WMA characteristics, if the second set of WMAs is executed in the region.

12. The non-transitory computer storage medium of claim 9, wherein the first WMA model is trained using training data comprising pre-WMA region data and post-WMA region data, the pre-WMA region data representing properties of each region in a set of regions prior to the set of WMAs being executed in each region of the set of regions, and the post-WMA region data representing properties of each region in the set of regions after the set of WMAs is actually executed in each region.

13. The non-transitory computer storage medium of claim 12, wherein post-WMA region data for each region is generated within a threshold time of the set of WMAs being actually executed in each region.

14. The non-transitory computer storage medium of claim 12, wherein post-WMA region data for each region is generated within a time period of a year that corresponds to the time period of a previous year, in which the set of WMAs is actually executed in each region.

15. The non-transitory computer storage medium of claim 9, wherein the set of WMAs comprises one or more of brush clearing, prescribed burn, and fire line formation.

16. The non-transitory computer storage medium of claim 9, wherein the first WMA learning model is one of a convolution neural network (CNN), a residual neural network (RNN), and a generative adversarial network (GAN).

17. A system, comprising:
one or more processors; and
a computer-readable storage device coupled to the one or more processors and having instructions stored thereon which, when executed by the one or more processors, cause the one or more processors to perform operations for using one or more machine learning (ML) models to mitigate effects of climate change by evaluating impact of wildfire mitigation actions (WMAs) for selective deployment of WMAs, the operations comprising:
receiving WMA data representative of a first set of WMAs that is to be evaluated for potential execution in the region;
providing, by a first WMA model processing the region data, first predicted WMA region data representative of the region, if the first set of WMAs was executed in the region;
providing, by a wildfire characteristic model processing the region data, pre-WMA characteristic data representative of one or more pre-WMA characteristics of a wildfire in the region;
providing, by the wildfire characteristic model processing the first predicted WMA region data, first post-WMA characteristic data representative of one or more post-WMA characteristics of a wildfire in the region; and
generating first impact results based on the pre-WMA characteristic data and the first post-WMA characteristic data, the first impact results representing an impact of the first set of WMAs on the one or more pre-WMA characteristics, if the first set of WMAs is executed in the region.

18. The system of claim 17, wherein operations further comprise selecting the first WMA model from a plurality of WMA models in response to the WMA data, the first WMA model being trained specific to the first set of WMAs.

19. The system of claim 17, wherein operations further comprise:
providing, by a second WMA model processing the region data, second predicted WMA region data representative of the region, if a second set of WMAs was executed in the region, the second set of WMAs being different from the first set of WMAs, the second WMA model being specific to the second set of WMAs;
providing, by the wildfire characteristic model processing the second predicted WMA region data, second post-WMA characteristic data representative of one or more post-WMA characteristics of a wildfire in the region; and
generating second impact results based on the pre-WMA characteristic data and the second post-WMA characteristic data, the second impact results representing an impact of the second set of WMAs on the one or more pre-WMA characteristics, if the second set of WMAs is executed in the region.

20. The system of claim 17, wherein the first WMA model is trained using training data comprising pre-WMA region data and post-WMA region data, the pre-WMA region data representing properties of each region in a set of regions prior to the set of WMAs being executed in each region of the set of regions, and the post-WMA region data representing properties of each region in the set of regions after the set of WMAs is actually executed in each region.

21. The system of claim 20, wherein post-WMA region data for each region is generated within a threshold time of the set of WMAs being actually executed in each region.

22. The system of claim 20, wherein post-WMA region data for each region is generated within a time period of a year that corresponds to the time period of a previous year, in which the set of WMAs is actually executed in each region.

23. The system of claim 17, wherein the set of WMAs comprises one or more of brush clearing, prescribed burn, and fire line formation.

24. The system of claim 17, wherein the first WMA learning model is one of a convolution neural network (CNN), a residual neural network (RNN), and a generative adversarial network (GAN).
